(19) United States
(12) Patent Application Publication
(10) Pub. No.: US 2012/0188348 A1
(43) Pub. Date: Jul. 26, 2012

(54) VIDEO DISPLAY DEVICE AND VIDEO VIEW SYSTEM

(76) Inventors: Yoshio Umeda, Hyogo (JP); Takahiro Kobayashi, Osaka (JP); Seiji Hamada, Osaka (JP); Satoshi Hirotsune, Hyogo (JP)

(21) Appl. No.: 13/357,054

(22) Filed: Jan. 24, 2012

Related U.S. Application Data
(63) Continuation of application No. PCT/JP2011/002988, filed on May 27, 2011.

(30) Foreign Application Priority Data
Jun. 9, 2010 (JP) 2010-131866

(51) Int. Cl. H04N 13/04

(52) U.S. Cl. 348/54; 348/E13.026

(57) ABSTRACT

A video display device and a video view system with which occurrence of crosstalk can be avoided in stereoscopic video images. The device has a liquid crystal panel on which the video image for the left eye corresponding to the video signal for the left eye and the video image for the right eye corresponding to the video signal for the right eye are displayed, and a driving unit which drives the liquid crystal panel by executing at least two times of write-scanning respectively according to the driving amount based on the respective video signal for the left or right eye, wherein in each write-scanning, the driving unit performs an overdrive operation in which the liquid crystal panel is driven according to a driving amount based on a target luminance.

### TECHNICAL FIELD

The present invention relates to a video display device on which video images are displayed for allowing a viewer to perceive the video images stereoscopically and a video view system with which the viewer can see the video images displayed on the display device.

### BACKGROUND ART

Conventional stereoscopic display devices where stereoscopic video images are produced include a stereoscopic display device wherein a video image for the left eye and a video image for the right eye that exhibit parallax are alternately rendered on a display at predetermined cycles (e.g., field frequency) and the resulting video images are observed with a glasses device for stereoscopic vision having liquid crystal shutters driven in synchronism with the predetermined cycles (see, for example, Patent Literatures 1 and 2).

FIG. 8 shows a block diagram showing a configuration of a conventional stereoscopic display system. A stereoscopic display system 300 shown in FIG. 8 comprises a stereoscopic display device 301 and a glasses device 302. The stereoscopic display device 301 comprises a stereoscopic video processing unit 101, a liquid crystal driving unit 102, a liquid crystal panel 103, a backlight 104, a left eye shutter control circuit 105L, a right eye shutter control circuit 105R, and a backlight control unit 106.

The stereoscopic video processing unit 101 is supplied with a video signal for the left eye and a video signal for the right eye, each at a frequency of 60 Hz. The stereoscopic video processing unit 101 converts the video signal for the left eye and the video signal for the right eye at the frequency of 60 Hz into a right-and-left video signal at a frequency of 120 Hz and supplies it to the liquid crystal driving unit 102 and the backlight control unit 106.

The liquid crystal driving unit 102 converts the 120 Hz right-and-left video signal from the stereoscopic video processing unit 101 into a format that the liquid crystal panel 103 can display, and supplies it to the liquid crystal panel 103. The backlight control unit 106 generates a light emission control signal for controlling light emission from the backlight 104 according to the 120 Hz right-and-left video signal from the stereoscopic video processing unit 101, and supplies it to the backlight 104.

The backlight 104 illuminates the liquid crystal panel 103 from behind according to the light emission control signal from the backlight control unit 106. The liquid crystal panel 103 alternately displays the video for the right and for the left eye at the frequency of 120 Hz.

On the other hand, the glasses device 302 comprises a left eye shutter 302L and a right eye shutter 302R. The left eye shutter control circuit 105L controls the opening and closing of the left eye shutter 302L in synchronization with the 120 Hz right-and-left video signal from the stereoscopic video processing unit 101. The right eye shutter control circuit 105R controls the opening and closing of the right eye shutter 302R in synchronization with the 120 Hz right-and-left video signal from the stereoscopic video processing unit 101.

FIG. 9 is a view showing a control timing chart in a conventional stereoscopic display device. The control timing chart in FIG. 9 represents the times at which video signals for the left eye and video signals for the right eye are written on the liquid crystal panel 103, the times at which the backlight 104 is illuminated, the times at which the right eye shutter 302R is opened and closed, and the times at which the left eye shutter 302L is opened and closed.

As shown in FIG. 9, the video signals for the right eye and the video signals for the left eye are successively written on the liquid crystal panel 103. The backlight control unit 106 controls the backlight 104 so that the duration of light emission is equal to ¼ of each video duration after the write-scanning of the video signal for the right eye or the video signal for the left eye on the liquid crystal panel 103.

In addition, the right eye shutter control circuit 105R controls the opening and closing of the right eye shutter 302R so that the duration shutter is opened is equal to ¼ of the video duration after the write-scanning of the video signal for the right eye on the liquid crystal panel 103. The left eye shutter control circuit 105L controls the opening and closing of the left eye shutter 302L so that the duration shutter is opened is equal to ¼ of the video duration after the write-scanning of the video signal for the left eye on the liquid crystal panel 103. The duration the right eye shutter 302R and the left eye shutter 302L are opened is controlled to be equal to the duration of light emission of the backlight 104. The video image for the left eye and the video image for the right eye which have passed through the left eye shutter 302L and the right eye shutter 302R are directed to the left and right eyes of a user. The brain puts the video images together and makes from them one visual stereoscopic impression.

In the aforementioned conventional stereoscopic display device, the liquid crystal panel 103 has a slow response to a drive voltage applied to the liquid crystal panel 103. As a result, writing of a subsequent video signal is initiated before the luminance reaches the target luminance.

FIG. 10 is a view for use in describing the crosstalk which is caused in the conventional stereoscopic display device. The timing chart shown in FIG. 10 represents a response of the light passing amount of the liquid crystal at a given pixel of the liquid crystal panel 103, the luminance of the backlight 104, the times at which the right eye shutter 302R and the left eye shutter 302L are opened and closed and the light passing amount of light passing therethrough, and a luminance after the light passes through the glasses shutter (luminance visually recognized by a person).

As shown in FIG. 10, the response of the light passing amount of the liquid crystal gradually approaches to the target light passing amount of images for the left eye during the period from the writing start time t1 for the video signal for the left eye to the writing end time t3 for the video signal for the left eye (writing start time for the video signal for the right eye). It gradually approaches the target light passing amount of images for the right eye during the period from the time t3 to the writing end time t5 for the video signal for the right eye.

Now, the luminance perceived by a person (hereinafter, referred to as a perceived luminance) is expressed as an integral equation for an instant luminance which is a product of a function f(t) representing the response of the light passing amount of the liquid crystal, a function g(t) representing the backlight luminance, and a function h(t) representing the light passing amount of the glasses shutter, as shown in the following equation (1).

perceived luminance=∫f(t)·g(t)·h(t)dt (1)

For example, for the video signal for the left eye, the following equation is true:

perceived luminance=∫^{t3}ₜ₁f(t)·g(t)·h(t)dt

and it corresponds to an area A in FIG. 10. In addition, for the video signal for the right eye, the following equation is true:

perceived luminance=∫^{t5}ₜ₃f(t)·g(t)·h(t)dt

and it corresponds to an area B in FIG. 10.

At the writing end time t3 for the video signal for the left eye, the luminance perceived by a person has not yet reached the target luminance of images for the left eye. Thus, it is perceived as darker by the amount of luminance corresponding to the area C in FIG. 10. This phenomenon is caused due to effect of an right eye image produced immediately before it, i.e., a part of the video image for the right eye is seen as being overlapped, and is called crosstalk. This crosstalk decreases the quality of the stereoscopic video images. In addition, at the writing end time t5 for the video signal for the right eye, the luminance perceived by a person has not yet reached the target luminance of images for the right eye. Thus, it is perceived as lighter by the amount of luminance corresponding to the area B in FIG. 10. Similar crosstalk to the one described above is caused. This crosstalk is caused due to the response speed of the liquid crystal panel 103. As described above, the liquid crystal panel 103 has a slow response to the drive voltage applied to the liquid crystal panel 103. The response of the light passing amount of the liquid crystal cannot reach the target light passing amount within the duration of light emission of the backlight 104 (from the time t2 to the time t3 and from the time t4 to the time t5), causing the crosstalk.

FIG. 11A is a view showing a video image for the right eye accompanied by crosstalk. FIG. 11B is a view showing a video image for the left eye with crosstalk. In FIG. 11A, a video image for the right eye RG has a black background image on which a white object S1 is displayed. In FIG. 11B, a video image for the left eye LG has a black background image on which a white object S2 is displayed.

As shown in FIGS. 11A and 11B, the video image for the right eye RG has the object S2 of the video image for the left eye LG overlapped therewith, and the video image for the left eye LG has the object S1 of the video image for the right eye RG overlapped therewith.

In order to avoid the occurrence of the crosstalk, an overdrive operation is preformed in which a drive voltage that is higher than the target voltage is applied to the liquid crystal panel 103. This can accelerate the response of the liquid crystal panel 103.

FIG. 12 is a view for use in describing an operation to reduce the crosstalk which is caused in the conventional stereoscopic display device. The timing chart shown in FIG. 12 represents a response of the light passing amount of the liquid crystal at a given pixel of the liquid crystal panel 103, the luminance of the backlight 104, the times at which the right eye shutter 302R and the left eye shutter 302L are opened and closed, a luminance after the light passes through the glasses shutter and the crosstalk.

The liquid crystal driving unit 102 shown in FIG. 12 performs the overdrive operation in which a drive voltage that is higher than the target voltage is applied to the liquid crystal panel 103. This accelerates the response to the liquid crystal panel 103, reducing the crosstalk. In FIG. 12, the overdrive operation is preformed in writing a video signal for the left eye. As a result, the target luminance of images for the left eye is achieved for a short period of time. Thus, a left eye shutter open period (t2 to t3) is enough to achieve the target luminance. In FIG. 12, the crosstalk corresponds to the area of a hatched region in the left eye shutter open period (t2 to t3) (almost compensated between the region lower than the target luminance and the region upper than that), which is reduced as compared with the case where no overdrive operation is performed.

However, as shown in FIG. 12, even though the overdrive operation is performed in the subsequent period for the right eye, the target luminance of images for the right eye has not yet reached in the right eye shutter open period (t4 to t5). This indicates that the crosstalk is caused corresponding to the area of the hatched region in the right eye shutter open period (t4 to t5). This is because the light passing amount of the liquid crystal becomes excessively high at the time t3 due to the overdrive operation in writing the image for the left eye, and thus the initial voltage in writing the image for the right eye becomes high, making it difficult to achieve the target light passing amount of images for the right eye within the right eye shutter open period. As apparent from the above, it is difficult to avoid the occurrence of the crosstalk by a single overdrive operation.

Patent Literature 1: Japanese Patent Application Laid-Open No. S62-133891 Patent Literature 2: Japanese Patent Application Laid-Open NO. 2009-25436

### SUMMARY OF THE INVENTION

The present invention was made in order to the aforementioned problems, and an object thereof is to provide a video display device and a video view system with which the occurrence of crosstalk in stereoscopic video images can be avoided.

A video display device according to one aspect of the present invention has a video display device has a video display unit on which the video image for the left eye corresponding to the video signal for the left eye and the video image for the right eye corresponding to the video signal for the right eye are displayed, and a driving unit which drives the video display unit by executing at least two times of write-scanning respectively according to the driving amount based on the video signal for the left eye or the video signal for the right eye, wherein in each write-scanning, the driving unit performs an overdrive operation in which the video display unit is driven according to a driving amount corresponding to the luminance that is equal to or higher than the target luminance when the video display unit is driven such that the luminance is enhanced to obtain the target luminance determined according to the video signal for the left eye or the video signal for the right eye, and the video display unit is driven according to a driving amount corresponding to the luminance that is equal to or lower than the target luminance when the video display unit is driven such that the luminance is suppressed to obtain the target luminance.

According to this configuration, the video display unit displays the video image for the left eye corresponding to the video signal for the left eye and the video image for the right eye corresponding to the video signal for the right eye. The driving unit drives the video display unit by executing at least two times of write-scanning respectively according to the driving amount on a basis of the video signal for the left eye or the video signal for the right eye. In executing respective write-scanning, the overdrive operation is performed in which the video display unit is driven according to a driving amount corresponding to the luminance that is equal to or higher than the target luminance when the video display unit is driven such that the luminance is enhanced to obtain the target luminance determined according to the video signal for the left eye or the video signal for the right eye, and the video display unit is driven according to a driving amount corresponding to the luminance that is equal to or lower than the target luminance when the video display unit is driven such that the luminance is suppressed to obtain the target luminance.

According to the present invention, the video display unit is driven according to a driving amount corresponding to the luminance that is equal to or higher than the target luminance when the video display unit is driven such that the luminance is enhanced to obtain the target luminance determined according to the video signal for the left eye or the video signal for the right eye, and the video display unit is driven according to a driving amount corresponding to the luminance that is equal to or lower than the target luminance when the video display unit is driven such that the luminance is suppressed to obtain the target luminance. Thus, the luminance of the video image for the left eye and the video image for the right eye displayed on the video display unit can be brought up to the target luminance, avoiding the occurrence of the crosstalk in stereoscopic video images.

Objects, features, and advantages of the present invention will be more apparent upon consideration of the following detailed description and the attached drawings.

### BRIEF DESCRIPTION OF THE DRAWINGS

FIG. 1 is a block diagram showing a configuration of a stereoscopic display system according to the Embodiment 1 of the present invention.

FIG. 2 is a view showing a control timing chart in the stereoscopic display system according to the Embodiment 1.

FIG. 3 is a view for use in describing an operation to reduce crosstalk which is caused in a stereoscopic display device according to the Embodiment 1.

FIG. 4 is a view showing the relationship between the a luminance in the current frame and a luminance in the previous frame.

FIG. 5 is a view for use in describing overdrive operations in first to third regions shown in FIG. 4.

FIG. 6A is a view showing a video image for the right eye displayed on a screen in the Embodiment 1, and FIG. 6B is a view showing a video image for the left eye displayed on the screen in the Embodiment 1.

FIG. 7 is a block diagram showing a configuration of a stereoscopic display system according to the Embodiment 2 of the present invention.

FIG. 8 is a block diagram showing a configuration of a conventional stereoscopic display system.

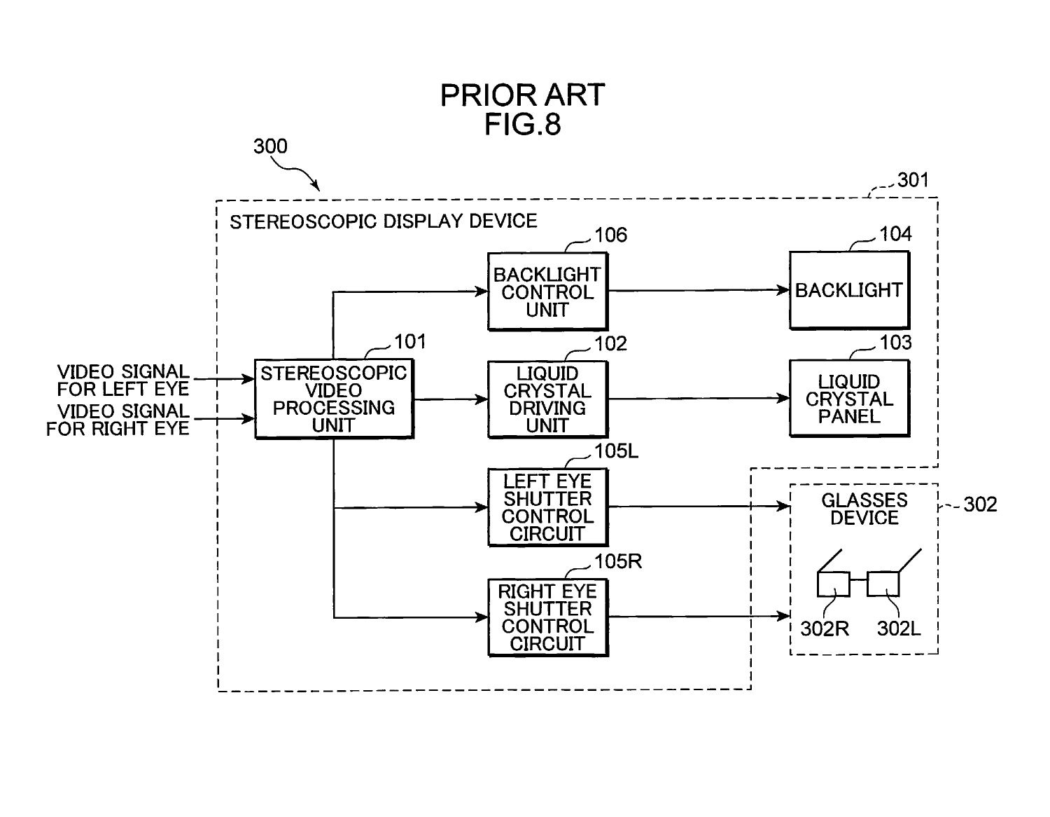

FIG. 9 is a view showing a control timing chart in a conventional stereoscopic display device.

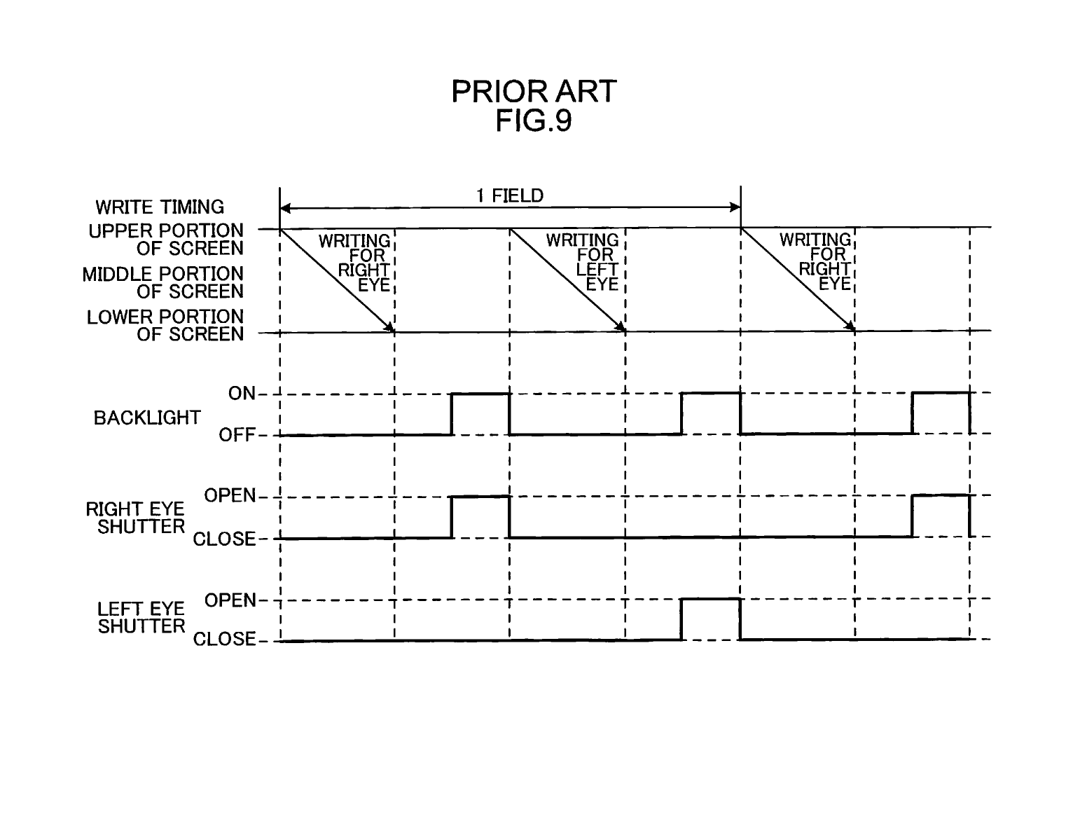

FIG. 10 is a view for use in describing crosstalk which is caused in the conventional stereoscopic display device.

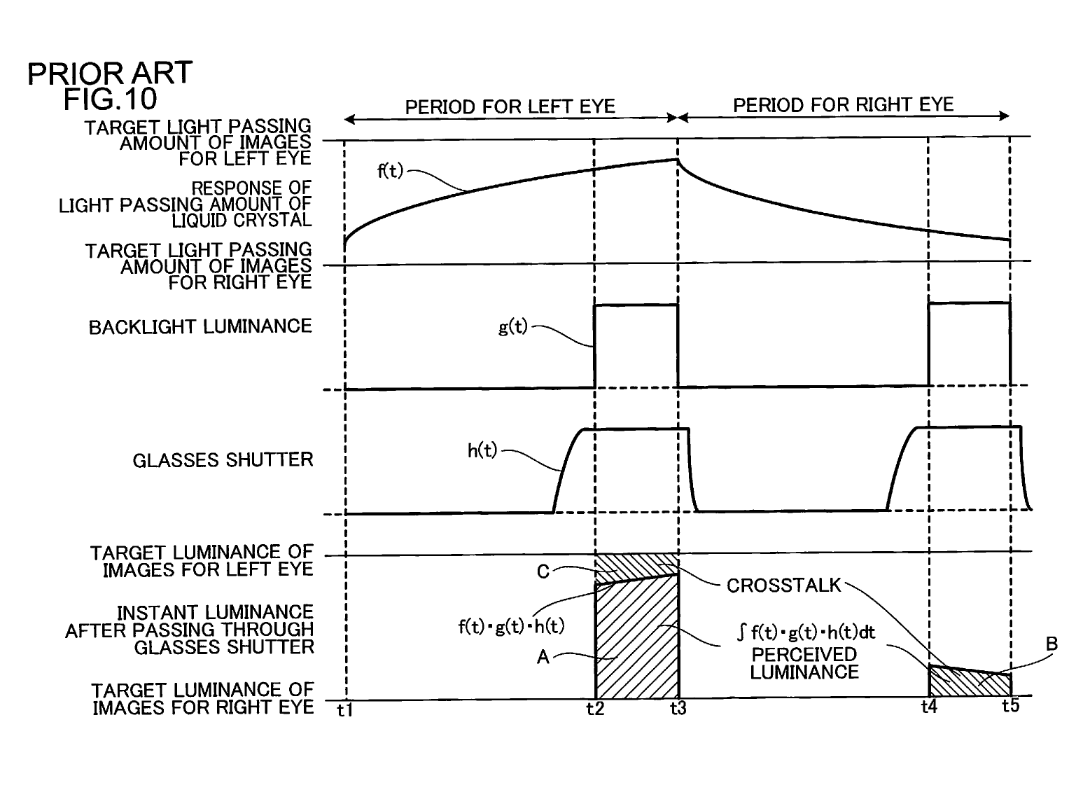

FIG. 11A is a view showing a video image for the right eye with crosstalk, and FIG. 11B is a view showing a video image for the left eye with crosstalk.

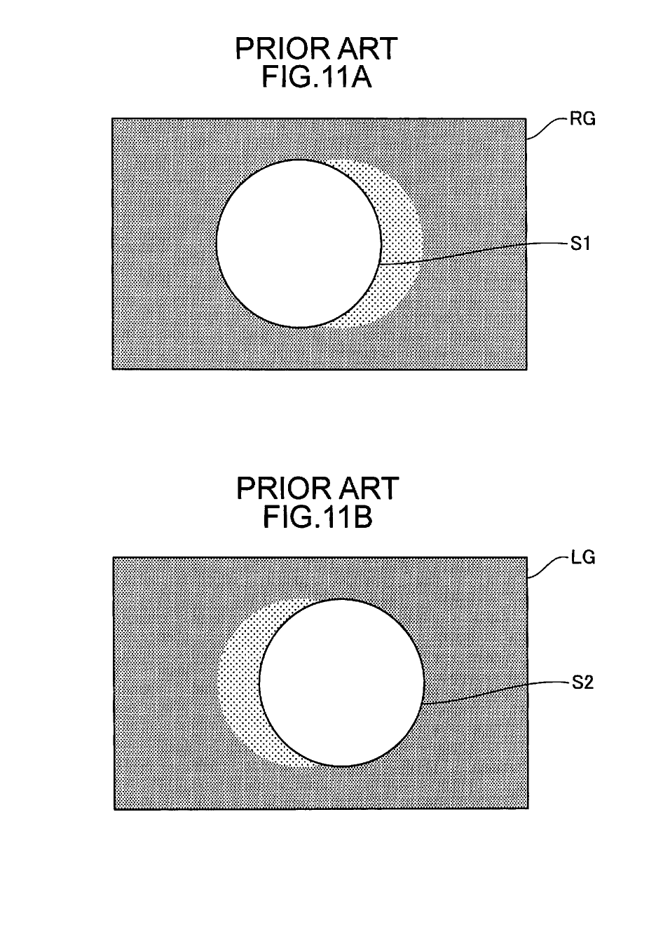

FIG. 12 is a view for use in describing an operation to reduce the crosstalk caused in the conventional stereoscopic display device.

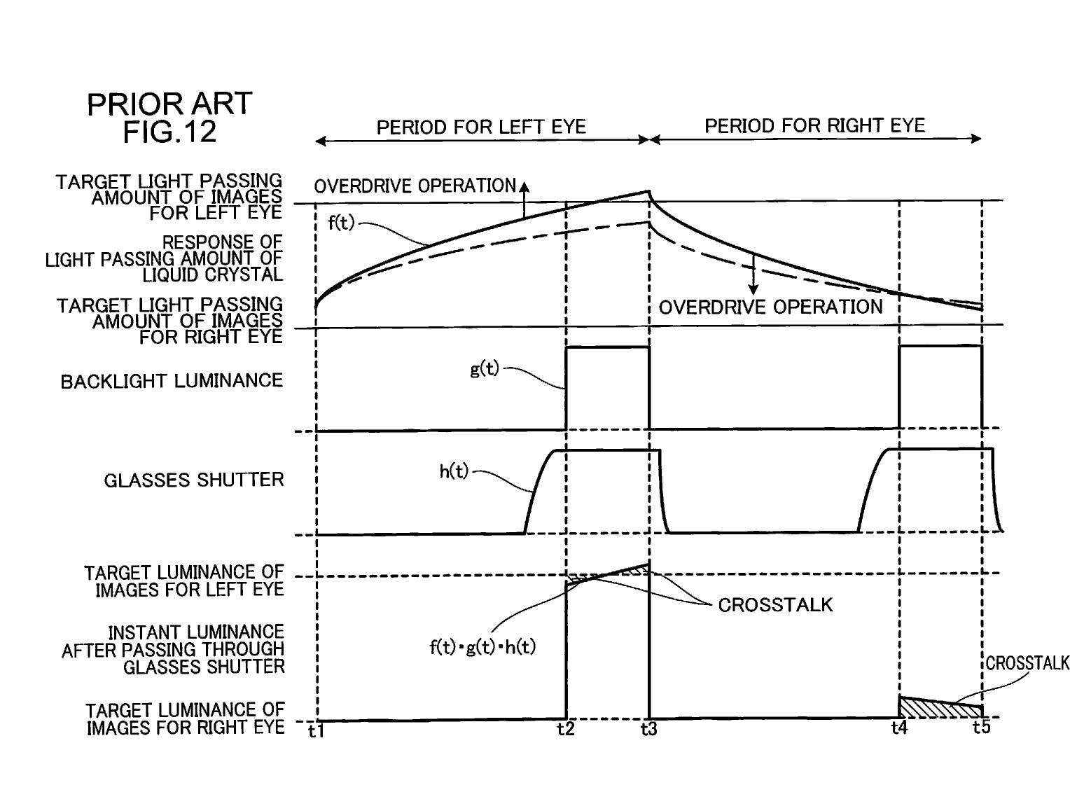

### DESCRIPTION OF THE INVENTION

Referring to the attached drawings, embodiments of the present invention are described. It should be noted that the following embodiments are only practical examples for the present invention, and do not limit any technical scope of the present invention.

### Embodiment 1

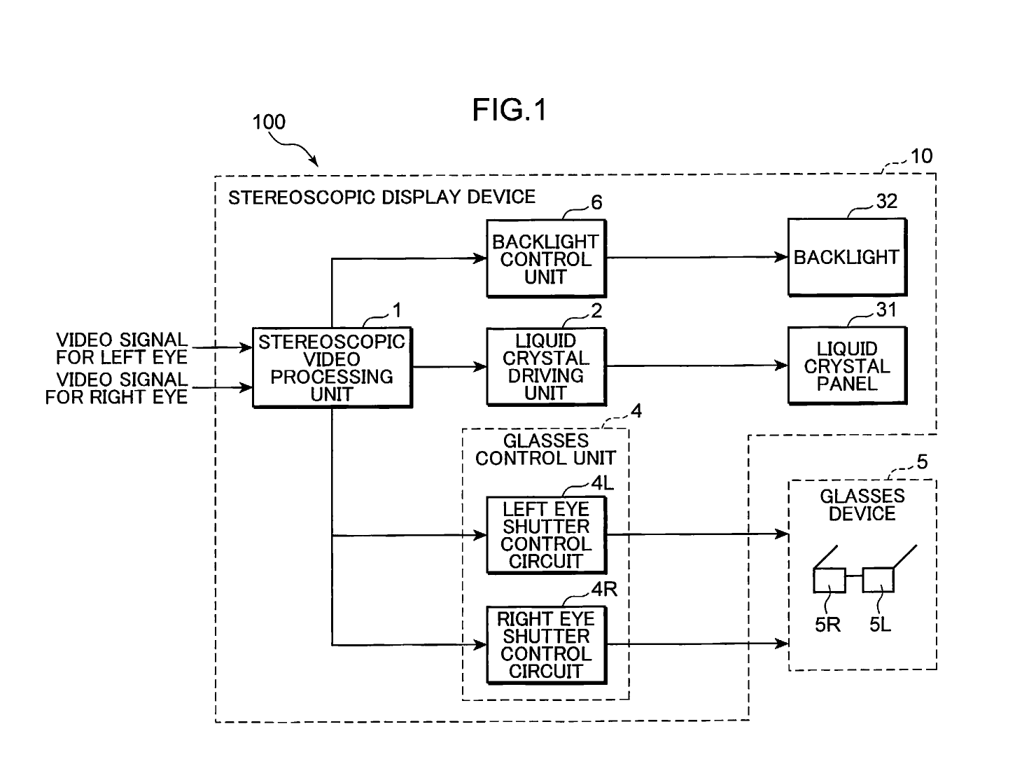

FIG. 1 is a block diagram showing a configuration of a stereoscopic display system according to the Embodiment 1 of the present invention. A stereoscopic display system 100 shown in FIG. 1 comprises a stereoscopic display device 10 and a glasses device 5. The glasses device 5 includes a left eye shutter 5L for adjusting the amount of light to be directed to the left eye of a viewer, and a right eye shutter 5R for adjusting the amount of light to be directed to the right of the viewer. The stereoscopic display device 10 controls the opening and closing of the left eye shutter 5L and the right eye shutter 5R for the video image for the left eye and the video image for the right eye.

The stereoscopic display device 10 comprises a stereoscopic video processing unit 1, a liquid crystal driving unit 2, a liquid crystal panel 31, a backlight 32, a glasses control unit 4, and a backlight control unit 6.

Video signals for the left eye and video signals for the right eye each having fundamental vertical synchronization frequency are supplied to the stereoscopic video processing unit 1. The stereoscopic video processing unit 1 converts the received video signals for the left eye and the received video signals for the right eye into a right-and-left video signal with a frequency N times (N is an integer equal to or larger than 1) as large as the fundamental vertical synchronization frequency and produces it, in which the right-and-left video signal is made up of alternate sequence of the video signals for the left eye and the video signals for the right eye. In this embodiment, the stereoscopic video processing unit 1 converts the received 60 Hz video signals for the left eye and the received 60 Hz video signals for the right eye into the right-and-left video signal (the video signals for the left eye and the video signals for the right eye) at the frequency of 120 Hz to supply it to the liquid crystal driving unit 2, the glasses control unit 4, and the backlight control unit 6. The stereoscopic video processing unit 1 may not produce some of the video signals for the left eye and the video signals for the right eye, if necessary. For example, the stereoscopic video processing unit 1 may supply only a synchronization signal at the frequency of 120 Hz to the glasses control unit 4.

The liquid crystal driving unit 2 drives the liquid crystal panel 31 by executing at least two times of write-scanning respectively according to the driving amount corresponding to the video signal for the left eye or the video signal for the right eye. The liquid crystal driving unit 2 converts the 120 Hz right-and-left video signal into a format that the liquid crystal panel 31 can display. The liquid crystal driving unit 2 supplies the converted right-and-left video signal to the liquid crystal panel 31. The liquid crystal driving unit 2 drives the liquid crystal panel 31 while controlling the transmittance thereof according to the driving amount corresponding to the video signal for the left eye or the video signal for the right eye.

In executing respective write-scanning, the liquid crystal driving unit 2 performs an overdrive operation in which the liquid crystal panel 31 is driven according to a driving amount corresponding to the luminance that is equal to or higher than the target luminance when the liquid crystal panel 31 is driven such that the luminance is enhanced to obtain the target luminance determined according to the video signal for the left eye or the video signal for the right eye, and the liquid crystal panel 31 is driven according to a driving amount corresponding to the luminance that is equal to or lower than the target luminance when the liquid crystal panel 31 is driven such that the luminance is suppressed to obtain the target luminance determined according to the video signal for the left eye or the video signal for the right eye.

In each of the period during which the video signal for the left eye in one field is written and the period during which the video signal for the right eye in one field is written, the liquid crystal driving unit 2 performs an overdrive operation at least twice in which the liquid crystal panel 31 is driven by a driving amount (applied voltage) appropriate for the transmittance that is equal to or higher than the transmittance required for the target luminance when the liquid crystal panel 31 is driven such that the transmittance is increased to obtain the target luminance determined according to the video signal for the left eye or the video signal for the right eye, and the liquid crystal panel 31 is driven according to a driving amount corresponding to the transmittance that is equal to or lower than the transmittance required for the target luminance when the liquid crystal panel 31 is driven such that the transmittance is decreased to obtain the target luminance determined according to the video signal for the left eye or the video signal for the right eye.

The liquid crystal panel 31 modulates light transmitted from the back according to the received video signal for the left eye and the received video signal for the right eye, and sequentially displays a video image for the left eye corresponding to the video signal for the left eye and a video image for the right eye corresponding to the video signal for the right eye. The liquid crystal panel 31 may be any panel that uses one of various technologies, such as an IPS (In Plane Switching) panel, a VA (Vertical Alignment) panel, or a TN (Twisted Nematic) panel. In addition, the combination of the liquid crystal panel 31 and the backlight 32 is an example of a video display unit. An organic EL panel may be used as the video display unit.

The backlight 32 illuminates the liquid crystal panel 31 from behind. The backlight 32 emits light in a direction perpendicular to the surface using a two dimensional array of light emitting diodes (LEDs). The backlight 32 may emit light in a direction perpendicular to the surface using a plurality of fluorescent tubes. Alternatively, the backlight 32 may be an edge lit backlight with rows of LEDs or fluorescent tubes along its edge(s), and is not limited to this embodiment.

The backlight 32 produces the light according to the light emission control signal supplied from the backlight control unit 6, based on the 120 Hz synchronization signal supplied from the stereoscopic video processing unit 1.

The glasses control unit 4 controls the opening and closing of the left eye shutter 5L and the right eye shutter 5R of the glasses device 5 in an opening and closing cycle depending on the display cycles specified by the video signal for the left eye and the video signal for the right eye. The glasses control unit 4 generates a glasses control signal for switching the polarization of the light passing through the glasses device 5 to the right and left eyes, in which the glasses device 5 alters the polarization state to transmit light to the right and left eyes alternately according to the video signal for the left eye and the video signal for the right eye. In this embodiment, the video signal for the left eye and the video signal for the right eye are displayed at the frequency of 120 Hz, so that the glasses control unit 4 controls the opening and closing cycles for each of the left eye shutter 5L and the right eye shutter 5R at 60 Hz. The glasses control unit 4 has a left eye shutter control circuit 4L and a right eye shutter control circuit 4R.

The left eye shutter control circuit 4L and the right eye shutter control circuit 4R determine a phase for the period during which the shutter is opened, based on the 120 Hz synchronization signal of the right-and-left video signal. The left eye shutter control circuit 4L generates a glasses control signal for the left eye for controlling the polarization state to transmit light to the left eye in synchronization with the right-and-left video signal. In addition, the right eye shutter control circuit 4R generates a glasses control signal for the right eye for controlling the polarization state to transmit light to the right eye in synchronization with the right-and-left video signal. Output signals from the left eye shutter control circuit 4L and the right eye shutter control circuit 4R serve to control the opening and closing state of the left eye shutter 5L and the right eye shutter 5R.

The glasses control unit 4 sets a pulse width for the period during which the left eye shutter 5L and the right eye shutter 5R are opened, and shutter opening/closing positions (phase during which the shutters are opened), in consideration with the response characteristics of the liquid crystal panel 31 and crosstalk between the video image for the left eye and the video image for the right eye. In this embodiment, the pulse width for the left eye shutter 5L and the right eye shutter 5R is equal to 25% (duty 25%) of a period (16.7 msec) for a video signal at the frequency of 60 Hz. The closed positions of the left eye shutter 5L and the right eye shutter 5R are defined as the respective positions where the writing of the left and right video signals, respectively, is terminated. The shutter opening/closing positions are controlled by the left eye shutter control circuit 4L and the right eye shutter control circuit 4R.

The backlight control unit 6 operates based on the 120 Hz synchronization signal from the stereoscopic video processing unit 1, and supplies the light emission control signal for controlling the backlight 32 to produce light in synchronization with the opening and closing positions of the left eye shutter 5L and the right eye shutter 5R.

It should be noted that, in this Embodiment 1, the stereoscopic display system 100 corresponds to an example of a video view system, and the stereoscopic display device 10 corresponds to an example of a video display device, the glasses device 5 corresponds to an example of the glasses device, the combination of the liquid crystal panel 31 and the backlight 32 corresponds to an example of the video display unit, the liquid crystal driving unit 2 corresponds to an example of a driving unit, and the glasses control unit 4 corresponds to an example of the glasses control unit.

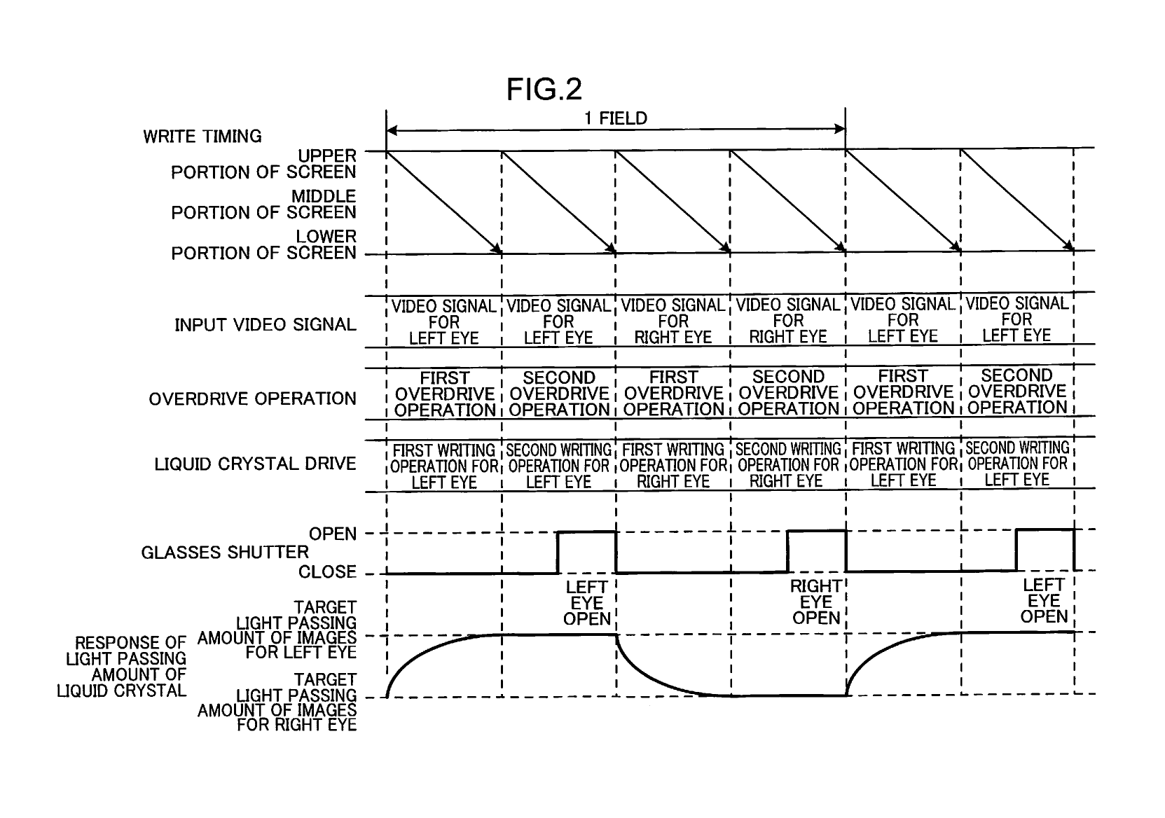

FIG. 2 is a view showing a control timing chart in the stereoscopic display system according to this Embodiment 1. The control timing chart in FIG. 2 represents the times at which video signals for the left eye and video signals for the right eye are written on the liquid crystal panel 31, the type of the video signals to be written, overdrive operations, driving operations for the liquid crystal panel 31, the times at which the left eye shutter 5L and the right eye shutter 5R are opened and closed, and a liquid crystal luminance response of the liquid crystal panel 31.

As shown in the writing timing, the video signals for the left eye or the video signals for the right eye are sequentially written into the liquid crystal panel 31, from the top to the bottom of the screen. In this embodiment, a single writing is completed for a period approximately quarter the period of one field (60 Hz=16.7 msec). In addition, after the completion of the writing, the same video signal is sequentially written. In other words, the liquid crystal driving unit 2 continuously writes the same video signal for the left eye twice in the period during which the video signal for the left eye in one field is written, and continuously writes the same video signal for the right eye twice in the period during which the video signal for the right eye in one field is written. In FIG. 2, in the period during which the video signal for the left eye is written, a first writing operation for the left eye and a second writing operation for the left eye are performed. In the period during which the video signal for the right eye is written, a first writing operation for the right eye and a second writing operation for the right eye are performed.

The left eye shutter 5L and the right eye shutter 5R are closed during the first writing operation and are opened along the way of the second writing operation, when the same video signal is written twice. Thus, a viewer does not recognize any video image during the first writing operation and views the video image along the way of the second writing operation.

This makes it possible to prevent the video image for the left eye and the video image for the right eye from being presented at the same time during the operation for writing the first video signal for the right eye to switch from the video signal for the left eye to the video signal for the right eye, and prevent the video image for the left eye and the video image for the right eye from being presented at the same time during the operation for writing the first video signal for the left eye to switch from the video signal for the right eye to the video signal for the left eye. It should be noted that the first writing operation for the left eye and the second writing operation for the left eye may be performed at a higher writing frequency and the left eye shutter 5L or the right eye shutter 5R may be opened after the second writing operation.

As described above, the liquid crystal driving unit 2 performs the first and second writing operations for each of the video signal for the left eye and the video signal for the right eye. In this event, the first overdrive operation in the first writing scan is different from the second overdrive operation in the second writing scan.

The liquid crystal driving unit 2 performs the first overdrive operation and the second overdrive operation in each of the period during which the video signal for the left eye in one field is written and the period during which the video signal for the right eye in one field is written. More specifically, the liquid crystal driving unit 2 performs the first overdrive operation when the first video signal for the left eye or video signal for the right eye is written, and performs the second overdrive operation when the second video signal for the left eye or video signal for the right eye is written.

In the first overdrive operation, the liquid crystal panel 31 is driven according to a driving amount corresponding to the luminance that is higher than the target luminance when the liquid crystal panel 31 is driven such that the luminance is enhanced to obtain the target luminance determined according to the video signal for the left eye or the video signal for the right eye, and the liquid crystal panel 31 is driven according to a driving amount corresponding to the luminance that is lower than the target luminance when the liquid crystal panel 31 is driven such that the luminance is suppressed to obtain the target luminance determined according to the video signal for the left eye or the video signal for the right eye.

In addition, in the second overdrive operation, the liquid crystal panel 31 is driven according to a driving amount corresponding to the luminance that is equal to the target luminance when the liquid crystal panel 31 is driven such that the luminance is enhanced to obtain the target luminance determined according to the video signal for the left eye or the video signal for the right eye, and the liquid crystal panel 31 is driven according to a driving amount corresponding to the luminance that is equal to the target luminance when the liquid crystal panel 31 is driven such that the luminance is suppressed to obtain the target luminance determined according to the video signal for the left eye or the video signal for the right eye.

The first overdrive operation applies a drive voltage that exceeds the drive voltage required for the target transmittance to the liquid crystal panel 31, thereby to bring the transmittance of the liquid crystal panel 31 up to the target transmittance. The second overdrive operation applies a drive voltage corresponding to the drive voltage required for the target transmittance to the liquid crystal panel 31, thereby to keep the transmittance of the liquid crystal panel 31 at the target transmittance.

In the example shown in FIG. 2, the liquid crystal driving unit 2 performs, in the first writing operation for the left eye, the first overdrive operation to apply a drive voltage that is higher than the drive voltage required for the target luminance of images for the left eye (the drive voltage required for the target transmittance of images for the left eye) to the liquid crystal panel 31, and performs, in the second writing operation for the left eye, the second overdrive operation to apply a drive voltage corresponding to the target luminance of images for the left eye (the drive voltage corresponding to the target transmittance of images for the left eye) to the liquid crystal panel 31. In addition, the liquid crystal driving unit 2 performs, in the first writing operation for the right eye, the first overdrive operation to apply a drive voltage that is lower than the drive voltage required for the target luminance of images for the right eye (the drive voltage required for the target transmittance of images for the right eye) to the liquid crystal panel 31, and performs, in the second writing operation for the right eye, the second overdrive operation to apply a drive voltage corresponding to the target luminance of images for the right eye (the drive voltage corresponding to the target transmittance of images for the right eye) to the liquid crystal panel 31.

It should be noted that, in this embodiment, the second overdrive operation applies a drive voltage corresponding to the drive voltage required for the target transmittance, but the present invention is not limited thereto. The second overdrive operation may apply a drive voltage that is higher than the drive voltage applied in the first overdrive operation, to the liquid crystal panel 31.

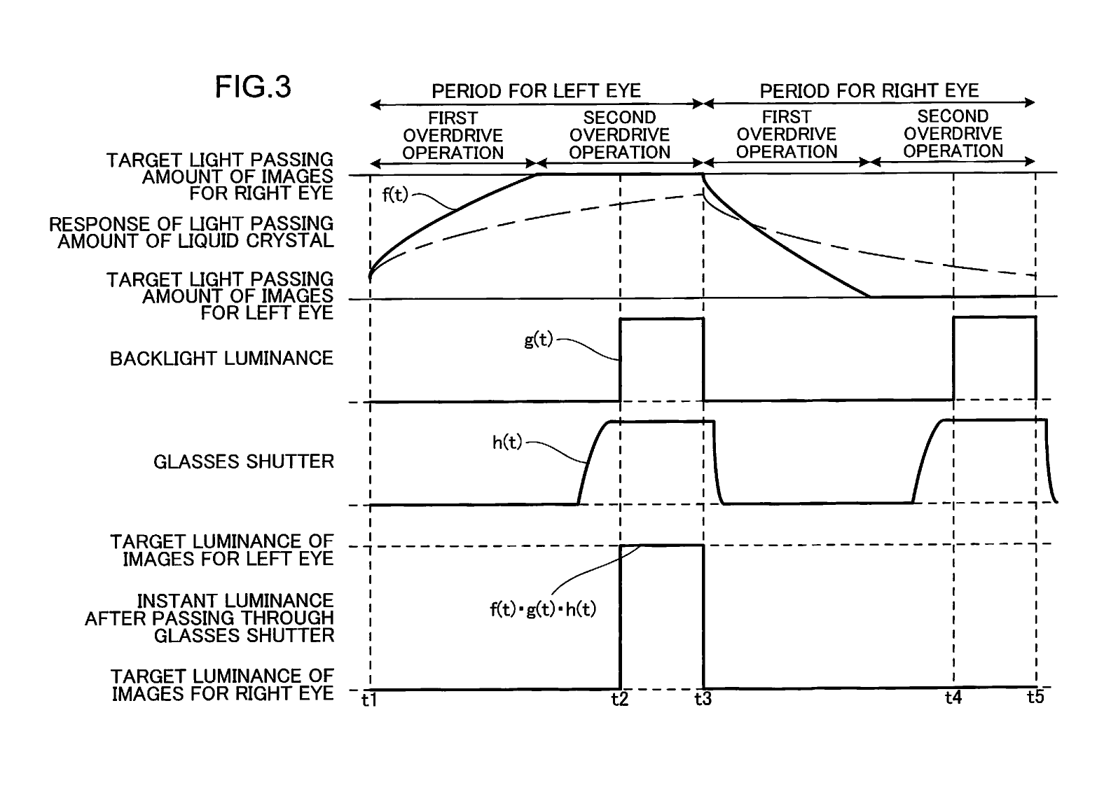

FIG. 3 is a view for use in describing an operation to reduce the crosstalk which is caused in the stereoscopic display device according to this Embodiment 1. The timing chart shown in FIG. 3 represents a response of the light passing amount of the liquid crystal of the liquid crystal panel 31, the luminance of the backlight 32, the times at which the right eye shutter 5R and the left eye shutter 5L are opened and closed, and an instant luminance after the light passes through the glasses shutter.

In conventional stereoscopic display devices, a drive voltage that is higher than the drive voltage required for the target luminance of images for the left eye is applied in only a single overdrive operation. As a result, it becomes necessary to use a higher initial voltage to apply the drive voltage required for the target luminance of images for the right eye next time. Thus, the response of the luminance cannot be reduced to the target luminance of images for the right eye, which is the cause of the crosstalk.

On the contrary, in this embodiment, a drive voltage that is higher than the drive voltage required for the target luminance of images for the left eye (the drive voltage required for the target transmittance of images for the left eye) is applied to the liquid crystal panel 31 in the first overdrive operation during the period for the left eye. This brings the luminance of the image(s) displayed on the liquid crystal panel 31 up to the target luminance of images for the left eye. In addition, the drive voltage corresponding to the target luminance of images for the left eye (the drive voltage corresponding to the target transmittance of images for the left eye) is applied to the liquid crystal panel 31 in the second overdrive operation. Thus, the luminance of the image(s) displayed on the liquid crystal panel 31 is kept at the target luminance of images for the left eye.

Next, a drive voltage that is lower than the drive voltage required for the target luminance of images for the right eye (the drive voltage required for the target transmittance of images for the right eye) is applied to the liquid crystal panel 31 in the first overdrive operation during the period for the right eye. This brings the luminance of the image(s) displayed on the liquid crystal panel 31 up to the target luminance of images for the right eye. In addition, the drive voltage corresponding to the target luminance of images for the right eye (the drive voltage corresponding to the target transmittance of images for the right eye) is applied to the liquid crystal panel 31 in the second overdrive operation. Thus, the luminance of the image(s) displayed on the liquid crystal panel 31 is kept at the target luminance of images for the right eye. This makes it possible to suppress the initial voltage upon application of the target voltage of images for the right eye, to reduce the response of the luminance (the response of the light passing amount of the liquid crystal) to the target luminance of images for the right eye, and to reduce the occurrence of the crosstalk.

In addition, the first overdrive operation may drive the liquid crystal panel 31 according to a driving amount corresponding to a first luminance that is higher than the target luminance when the liquid crystal panel 31 is driven such that the luminance is enhanced to obtain the target luminance determined according to the video signal for the left eye or the video signal for the right eye, and it may drive the liquid crystal panel 31 according to a driving amount corresponding to a second luminance that is lower than the target luminance when the liquid crystal panel 31 is driven such that the luminance is suppressed to obtain the target luminance determined according to the video signal for the left eye or the video signal for the right eye.

In addition, the second overdrive operation may drive the liquid crystal panel 31 according to a driving amount corresponding to a third luminance that is higher than the target luminance and lower than the first luminance when the liquid crystal panel 31 is driven such that the luminance is enhanced to obtain the target luminance determined according to the video signal for the left eye or the video signal for the right eye, and may drive the liquid crystal panel 31 according to a driving amount corresponding to a fourth luminance that is lower than the target luminance and higher than the second luminance when the liquid crystal panel 31 is driven such that the luminance is suppressed to obtain the target luminance determined according to the video signal for the left eye or the video signal for the right eye.

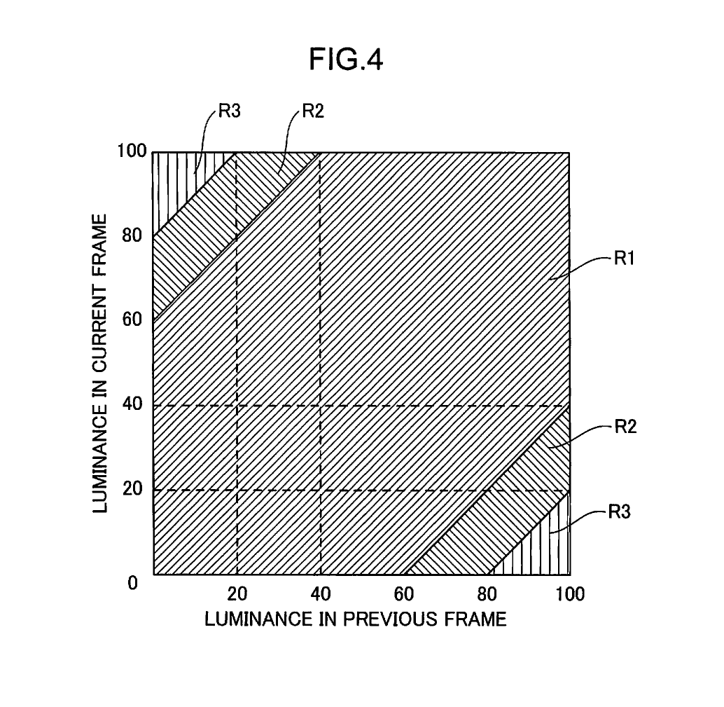

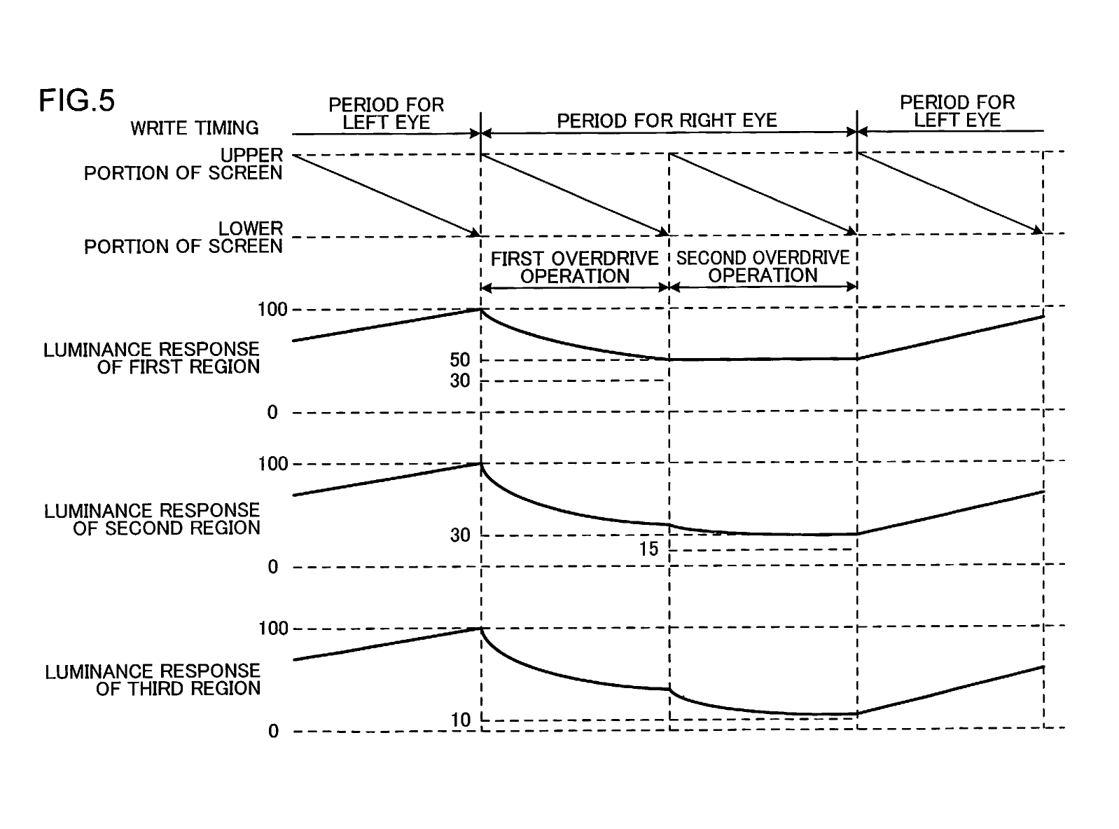

Next, another example of the overdrive operation in this Embodiment 1 is described. FIG. 4 is a view showing the relationship between a luminance in the current frame and a luminance in the previous frame. FIG. 5 is a view for use in describing overdrive operations in first to third regions shown in FIG. 4.

In FIG. 4, the abscissas represents the luminance in the previous frame while the ordinate represents the luminance in the current frame. A single frame is the duration during which either one of the video signal for the right eye and the video signal for the left eye within one field is displayed.

In FIG. 4, it is assumed that the luminance in the previous frame be X, the luminance in the current frame be Y, a first region R1 be X−60<Y<X+60, a second region R2 be X−80<Y≦X−60 and X+80<Y≦X+60, and a third region R3 be 0≦Y≦X−80 and X+80≦Y≦100, provided that X satisfies 0≦X≦100.

When the luminance in the previous frame and the luminance in the current frame fall within the first region R1, the luminance of the image(s) displayed on the liquid crystal panel 31 reaches the target luminance to display the video image(s) corresponding to the video signal only in one overdrive operation. When the luminance in the previous frame and the luminance in the current frame fall within the second region R2, the luminance of the image(s) displayed on the liquid crystal panel 31 reaches the target luminance in two overdrive operations. On the other hand, when the luminance in the previous frame and the luminance in the current frame fall within the third region R3, the luminance of the image(s) displayed on the liquid crystal panel 31 does not reach the target luminance in the two overdrive operations.

As shown in FIG. 5, for example, when the luminance of the video signal for the left eye in the previous frame is equal to 100, and the luminance of the video signal for the right eye in the current frame is equal to 50, the luminance in the previous frame and the luminance in the current frame both fall within the first region R1. In this event, the liquid crystal driving unit 2 performs the first overdrive operation using a set luminance value (set drive voltage) of 30. Thus, upon completion of the first writing operation for the left eye, the luminance of the image(s) displayed on the liquid crystal panel 31 is reduced from 100 to 50. At this point, the luminance in the current frame has reached the target luminance which is equal to 50. Thus, the liquid crystal driving unit 2 performs the second overdrive operation using the set luminance value of 50. In this way, in the second writing operation for the left eye, the luminance of the image(s) displayed on the liquid crystal panel 31 is kept at the target luminance which is equal to 50.

As apparent from the above, when the luminance in the previous frame and the luminance in the current frame fall within the first region R1, the liquid crystal driving unit 2 drives the liquid crystal panel 31 in such a manner that the luminance is reduced to the target luminance by the first overdrive operation, and the target luminance is kept by the second overdrive operation. This makes it possible to prevent the luminance of the image(s) displayed on the liquid crystal panel 31 from being decreased below the target luminance, suppressing the occurrence of the crosstalk.

In addition, for example, when the luminance of the video signal for the left eye in the previous frame is equal to 100, and the luminance of the video signal for the right eye in the current frame is equal to 30, the luminance in the previous frame and the luminance in the current frame both fall within the second region R2. In this event, the liquid crystal driving unit 2 performs the first overdrive operation using a set luminance value of to 0. Thus, upon completion of the first writing operation for the left eye, the luminance of the liquid crystal panel 31 is reduced from 100 to 40. At this point, the luminance in the current frame has not yet reached the target luminance which is equal to 30. Thus, the liquid crystal driving unit 2 performs the second overdrive operation using the set luminance value of 15. In this way, upon completion of the second writing operation for the left eye, the luminance of the image(s) displayed on the liquid crystal panel 31 reaches the target luminance which is equal to 30.

It should be noted that, in the second overdrive operation, the luminance of the image(s) displayed on the liquid crystal panel 31 is smaller than the target luminance when the set luminance value is equal to 0, and the luminance of the image(s) displayed on the liquid crystal panel 31 does not reach the target luminance when the set luminance value is equal to 30. Thus, the liquid crystal driving unit 2 performs the second overdrive operation using the set luminance value of 15.

As apparent from the above, when the luminance in the previous frame and the luminance in the current frame fall within the second region R2, the liquid crystal driving unit 2 drives the liquid crystal panel 31 in such a manner that the luminance is reduced to a predetermined luminance that is higher than the target luminance by the first overdrive operation, and the predetermined luminance is reduced to the target luminance by the second overdrive operation. This makes it possible to prevent the luminance of the image(s) displayed on the liquid crystal panel 31 from being decreased below the target luminance, and from not reaching the target luminance, suppressing the occurrence of the crosstalk.

In addition, for example, when the luminance of the video signal for the left eye in the previous frame is equal to 100, and the luminance of the video signal for the right eye in the current frame is equal to 10, the luminance in the previous frame and the luminance in the current frame both fall within the third region R3. In this event, the liquid crystal driving unit 2 performs the first overdrive operation using the set luminance value of 0, and performs the second overdrive operation using the set luminance value of 0. At this point, the luminance in the current frame has not yet reached the target luminance which is equal to 10. This means that when there is a significant difference between the luminance in the previous frame and the luminance in the current frame, two overdrive operations are not enough to reach the target luminance, leaving the crosstalk. However, the crosstalk can be reduced as compared with the case where only one overdrive operation is performed.

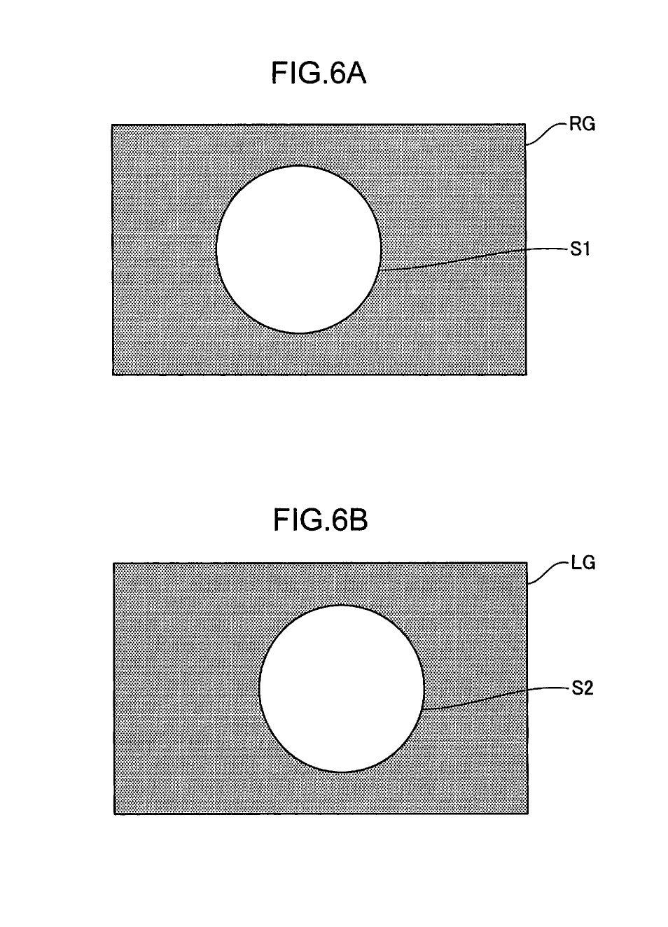

FIG. 6A is a view showing a video image for the right eye displayed on a screen in this Embodiment 1, and FIG. 6B is a view showing a video image for the left eye displayed on the screen in this Embodiment 1. In FIG. 6A, a video image for the right eye RG has a black background image on which a white object S1 is displayed. In FIG. 6B, a video image for the left eye LG has a black background image on which a white object S2 is displayed.

As shown in FIGS. 6A and 6B, since the occurrence of the crosstalk can be suppressed in this embodiment, only the object S1 is displayed on the video image for the right eye RG, and only the object S2 is displayed on the video image for the left eye LG. This contributes to improving the quality of the image in stereoscopic video images.

It should be noted that, in this embodiment, the liquid crystal driving unit 2 may alter the drive voltage to be applied during the first overdrive operation and the second overdrive operation according to the times at which the left eye shutter 5L and the right eye shutter 5R are opened and closed that are controlled by the left eye shutter control circuit 4L and the right eye shutter control circuit 4R, respectively.

More specifically, the liquid crystal driving unit 2 increases the drive voltage for the first overdrive operation and the second overdrive operation when positions are assumed where opening of the left eye shutter 5L and the right eye shutter 5R are advanced.

When the positions are assumed where the opening of the left eye shutter 5L and the right eye shutter 5R relative to the glasses control signal are advanced, the crosstalk will be increased because the response of the liquid crystal is not completed as usual. However, in this embodiment, the drive voltage is altered in the overdrive operations according to the times at which the left eye shutter 5L and the right eye shutter 5R are opened and closed, relative to the glasses control signal. As a result, the drive voltage applied during the overdrive operation can be increased when the positions are assumed where opening of the left eye shutter 5L and the right eye shutter 5R are advanced relative to the glasses control signal, which makes it possible to reduce the crosstalk.

### Embodiment 2

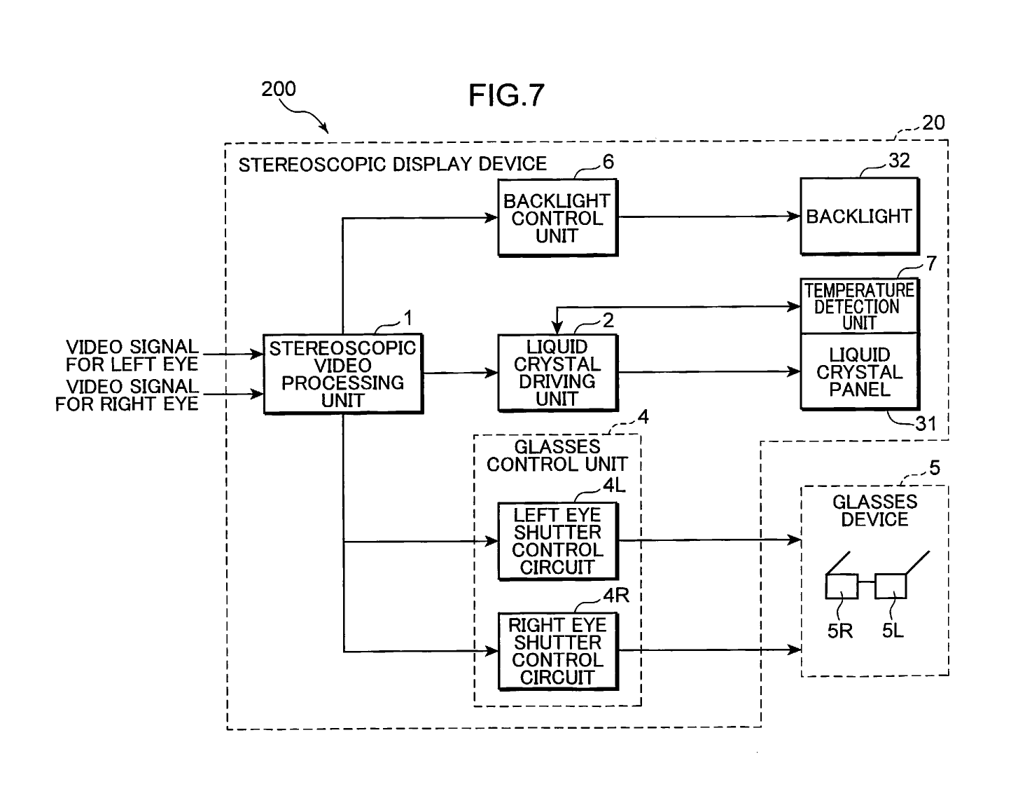

Next, a stereoscopic display system according to an Embodiment 2 of the present invention is described. FIG. 7 is a block diagram showing a configuration of a stereoscopic display system according to the Embodiment 2 of the present invention. A stereoscopic display system 200 shown in FIG. 7 comprises a stereoscopic display device 20 and the glasses device 5. It should be noted that, in the stereoscopic display system 200 shown in FIG. 7, similar components and parts to those in the Embodiment 1 are depicted by the like reference numerals, and description thereof will be omitted.

The stereoscopic display device 20 comprises the stereoscopic video processing unit 1, the liquid crystal driving unit 2, the liquid crystal panel 31, the backlight 32, the glasses control unit 4, the backlight control unit 6, and a temperature detection unit 7. In this Embodiment 2, the stereoscopic display system 200 corresponds to an example of a video view system, and the stereoscopic display device 20 corresponds to an example of a video display device, and the temperature detection unit 7 corresponds to an example of a temperature detection unit.

The temperature detection unit 7 detects the temperature of the liquid crystal panel 31 and supplies a panel temperature signal based on the detected value to the liquid crystal driving unit 2. The liquid crystal driving unit 2 alters the driving amount in the overdrive operation according to the temperature detected by the temperature detection unit 7.

In general, the lower the temperature of the liquid crystal panel 31 is, the slower the response speed of the liquid crystal, which tends to increase the crosstalk. Taking this into consideration, the liquid crystal driving unit 2 increases the driving amount of driving in the overdrive operation as the temperature detected by the temperature detection unit 7 decreases.

More specifically, the liquid crystal driving unit 2 performs the overdrive operation in such a manner that the lower the temperature detected by the temperature detection unit 7 is, the larger the difference between the driving amount corresponding to the target luminance determined depending on the video signal for the left eye or the video signal for the right eye and the driving amount in the overdrive operation becomes.

For example, the liquid crystal driving unit 2 increases the set drive voltages (gain values) in the first overdrive operation and the second overdrive operation according to the amount of decrease in detected temperature from a predetermined threshold value when the temperature detected by the temperature detection unit 7 is smaller than a predetermined threshold value. The liquid crystal driving unit 2 previously stores a table in which temperatures are associated with amounts of increase in set drive voltage in the first overdrive operation and the second overdrive operation. The liquid crystal driving unit 2 reads the amount of increase in set drive voltage corresponding to the detected temperature from the table when the temperature detected by the temperature detection unit 7 is smaller than the predetermined threshold value, and adds the read amount of increase to the set drive voltage, to perform the first overdrive operation and the second overdrive operation.

It should be noted that, in this embodiment, the liquid crystal driving unit 2 previously stores the table, but the present invention is not limited thereto. The set drive voltage that increases as the temperature detected by the temperature detection unit 7 decreases may be calculated based on a predetermined calculation formula.

In addition, in this embodiment, the liquid crystal driving unit 2 determines whether the temperature detected by the temperature detection unit 7 is smaller than the predetermined threshold value. However, the present invention is not limited thereto. The liquid crystal driving unit 2 may read the amount of increase in set drive voltage corresponding to the detected temperature from the table without the aforementioned determination, and add the read amount of increase to the set drive voltage, to perform the first overdrive operation and the second overdrive operation.

In addition, it is sufficient that the temperature detection unit 7 detects the temperature at a predetermined position in the liquid crystal panel 31. For example, the temperature detection unit 7 detects the temperature at either one of the upper, middle, and lower portions of the liquid crystal panel 31. Furthermore, the temperature detection unit 7 may detect the temperatures at a plurality of positions in the liquid crystal panel 31, such us the upper, middle, and lower portions of the liquid crystal panel 31, to calculate an average value of the temperatures.

Moreover, the temperature detection unit 7 may detect the temperatures of each region of the liquid crystal panel 31 divided into a plurality of regions. In this case, the liquid crystal driving unit 2 alters the drive voltage to be applied in the first overdrive operation and the second overdrive operation for each region, according to the temperatures of the regions detected by the temperature detection unit 7. For example, the temperature detection unit 7 detects the temperatures at the upper, middle, and lower portions of the liquid crystal panel 31.

According to this Embodiment 2, the drive voltage to be applied in the overdrive operation is altered depending on the temperature of the liquid crystal panel 31, so that the drive voltage to be applied in the overdrive operation can be increased when the temperature of the liquid crystal panel 31 is decreased, reducing the amount of the crosstalk.

It should be noted, in the Embodiment 1 and Embodiment 2, the liquid crystal driving unit 2 performs the overdrive operation twice in each of the period during which the video signal for the left eye in one field is written and the period during which the video signal for the right eye in one field is written, but the present invention is not limited thereto. The liquid crystal driving unit 2 may perform the overdrive operation three or more times in each of the period during which the video signal for the left eye in one field is written and the period during which the video signal for the right eye in one field is written.

It should be noted that the aforementioned specific embodiments include the invention mainly having the following configuration.

A video display device according to one aspect of the present invention has a video display device has a video display unit on which the video image for the left eye corresponding to the video signal for the left eye and the video image for the right eye corresponding to the video signal for the right eye are displayed, and a driving unit which drives the video display unit by executing at least two times of write-scanning respectively according to the driving amount based on the video signal for the left eye or the video signal for the right eye, wherein in each write-scanning, the driving unit performs an overdrive operation in which the video display unit is driven according to a driving amount corresponding to the luminance that is equal to or higher than the target luminance when the video display unit is driven such that the luminance is enhanced to obtain the target luminance determined according to the video signal for the left eye or the video signal for the right eye, and the video display unit is driven according to a driving amount corresponding to the luminance that is equal to or lower than the target luminance when the video display unit is driven such that the luminance is suppressed to obtain the target luminance.

According to this configuration, the video display unit displays the video image for the left eye corresponding to the video signal for the left eye and the video image for the right eye corresponding to the video signal for the right eye. The driving unit drives the video display unit by executing at least two times of write-scanning respectively according to the driving amount corresponding to the video signal for the left eye or the video signal for the right eye. In executing respective write-scanning, the overdrive operation is performed in which the video display unit is driven according to a driving amount corresponding to the luminance that is equal to or higher than the target luminance when the video display unit is driven such that the luminance is enhanced to obtain the target luminance determined according to the video signal for the left eye or the video signal for the right eye, and the video display unit is driven according to a driving amount corresponding to the luminance that is equal to or lower than the target luminance when the video display unit is driven such that the luminance is suppressed to obtain the target luminance.

As apparent from the above, the video display unit is driven according to a driving amount corresponding to the luminance that is equal to or higher than the target luminance when the video display unit is driven such that the luminance is enhanced to obtain the target luminance determined according to the video signal for the left eye or the video signal for the right eye, and the video display unit is driven according to a driving amount corresponding to the luminance that is equal to or lower than the target luminance when the video display unit is driven such that the luminance is suppressed to obtain the target luminance. Thus, the luminance of the video image for the left eye and the video image for the right eye displayed on the video display unit can be brought up to the target luminance, avoiding the occurrence of the crosstalk in stereoscopic video images.

A video display device according to another aspect of the present invention comprises a video display unit on which the video image for the left eye corresponding to the video signal for the left eye and the video image for the right eye corresponding to the video signal for the right eye are displayed, and a driving unit which drives the video display unit by write-scanning according to the driving amount corresponding to the video signal for the left eye or the video signal for the right eye, the driving unit performing first write-scanning and second write-scanning for the video signal for the left eye and the video signal for the right eye, respectively, and in each of the first write-scanning and second write-scanning, the video display unit being driven according to a driving amount corresponding to the luminance that is equal to or higher than the target luminance when the video display unit is driven such that the luminance is enhanced to obtain the target luminance determined according to the video signal for the left eye or the video signal for the right eye, to make the first overdrive operation in the first write-scanning different from the second overdrive operation in the second write-scanning

According to this configuration, the video image for the left eye corresponding to the video signal for the left eye and the video image for the right eye corresponding to the video signal for the right eye are displayed by the video display unit, and the video display unit is driven by the driving unit by write-scanning according to the driving amount corresponding to the video signal for the left eye or the video signal for the right eye. The first write-scanning and the second write-scanning are performed for the video signal for the left eye and the video signal for the right eye, respectively. In each of the first write-scanning and second write-scanning, the video display unit is driven according to a driving amount corresponding to the luminance that is equal to or higher than the target luminance when the video display unit is driven such that the luminance is enhanced to obtain the target luminance determined according to the video signal for the left eye or the video signal for the right eye. Thus, the first overdrive operation in the first write-scanning is different from the second overdrive operation in the second write-scanning

As apparent from the above, two overdrive operations are performed in each of the period during which the video signal for the left eye is written and the period during which the video signal for the right eye is written. Thus, the luminance of the video image for the left eye and the video image for the right eye displayed on the video display unit can be brought up to the target luminance, avoiding the occurrence of the crosstalk in stereoscopic video images.

In addition, in the aforementioned video display device, it is preferable that the first overdrive operation drives the video display unit according to a driving amount corresponding to the luminance that is higher than the target luminance when the video display unit is driven such that the luminance is enhanced to obtain the target luminance, and drives the video display unit according to a driving amount corresponding to the luminance that is lower than the target luminance when the video display unit is driven such that the luminance is suppressed to obtain the target luminance, and that the second overdrive operation drives the video display unit according to a driving amount corresponding to the luminance that is equal to the target luminance when the video display unit is driven such that the luminance is enhanced to obtain the target luminance, and drives the video display unit according to a driving amount corresponding to the luminance that is equal to the target luminance when the video display unit is driven such that the luminance is suppressed to obtain the target luminance.

According to this configuration, in the first overdrive operation, the video display unit is driven according to a driving amount corresponding to the luminance that is higher than the target luminance when the video display unit is driven such that the luminance is enhanced to obtain the target luminance, and the video display unit is driven according to a driving amount corresponding to the luminance that is lower than the target luminance when the video display unit is driven such that the luminance is suppressed to obtain the target luminance. In addition, in the second overdrive operation, the video display unit is driven according to a driving amount corresponding to the luminance that is equal to the target luminance when the video display unit is driven such that the luminance is enhanced to obtain the target luminance, and the video display unit is driven according to a driving amount corresponding to the luminance that is equal to the target luminance when the video display unit is driven such that the luminance is suppressed to obtain the target luminance.

As apparent from the above, the luminance can be brought up to the target luminance in the first overdrive operation, and the luminance can be kept at the target luminance in the second overdrive operation, avoiding the occurrence of the crosstalk in stereoscopic video images.

In addition, in the aforementioned video display device, it is preferable that the first overdrive operation drives the video display unit according to a driving amount corresponding to a first luminance that is higher than the target luminance when the video display unit is driven such that the luminance is enhanced to obtain the target luminance, and drives the video display unit according to a driving amount corresponding to a second luminance that is lower than the target luminance when the video display unit is driven such that the luminance is suppressed to obtain the target luminance, and that the second overdrive operation drives the video display unit according to a driving amount corresponding to a third luminance that is higher than the target luminance and lower than the first luminance when the video display unit is driven such that the luminance is enhanced to obtain the target luminance, and drives the video display unit according to a driving amount corresponding to a fourth luminance that is lower than the target luminance and higher than the second luminance when the video display unit is driven such that the luminance is suppressed to obtain the target luminance.

According to this configuration, in the first overdrive operation, the video display unit is driven according to a driving amount corresponding to the first luminance that is higher than the target luminance when the video display unit is driven such that the luminance is enhanced to obtain the target luminance, and the video display unit is driven according to a driving amount corresponding to the second luminance that is lower than the target luminance when the video display unit is driven such that the luminance is suppressed to obtain the target luminance. In addition, in the second overdrive operation, the video display unit is driven according to a driving amount corresponding to the third luminance that is higher than the target luminance and lower than the first luminance when the video display unit is driven such that the luminance is enhanced to obtain the target luminance, and the video display unit is driven according to a driving amount corresponding to the fourth luminance that is lower than the target luminance and higher than the second luminance when the video display unit is driven such that the luminance is suppressed to obtain the target luminance.

As apparent from the above, the first overdrive operation brings the luminance to the vicinity of the target luminance sooner, and the second overdrive operation can bring the luminance to the target luminance, avoiding the occurrence of the crosstalk in stereoscopic video images.

In addition, it is preferable that the aforementioned video display device further comprises a temperature detection unit for detecting the temperature of the video display unit, and the driving unit alters the driving amount of driving in the overdrive operation according to the temperature detected by the temperature detection unit.

When the temperature of the video display unit is decreased, the response speed of the video display unit is also reduced, which increases the amount of the crosstalk. However, according to this configuration, the driving amount of driving in the overdrive operation is altered according to the temperature of the video display unit, so that the driving amount of driving in the overdrive operation can be increased when the temperature of the video display unit is decreased, reducing the amount of the crosstalk.

Furthermore, in the aforementioned video display device, it is preferable that the driving unit performs the overdrive operation in such a manner that the lower the temperature detected by the temperature detection unit is, the larger the difference between the driving amount corresponding to the target luminance determined depending on the video signal for the left eye or the video signal for the right eye and the driving amount in the overdrive operation becomes.

According to this configuration, the overdrive operation is performed in such manner that the lower the temperature detected by the temperature detection unit is, the larger the difference between the driving amount corresponding to the target luminance determined depending on the video signal for the left eye or the video signal for the right eye and the driving amount in the overdrive operation becomes, so that the driving amount in the overdrive operation can be increased when the temperature of the video display unit is decreased, reducing the amount of the crosstalk.

In addition, it is preferable that the aforementioned video display device further comprises a glasses control unit which generates a glasses control signal for switching between the right and left eyes the light transmittance through the glasses device that transmits the light alternately towards the right and left eyes according to the video signal for the left eye and the video signal for the right eye, wherein the driving unit alters the driving amount of driving in the overdrive operation according to the times at which the light transmittance through the glasses device is switched in response to the glasses control signal generated by the glasses control unit.

According to this configuration, the glasses control unit generates a glasses control signal for switching between the right and left eyes the light transmittance through the glasses device that transmits the light alternately towards the right and left eyes according to the video signal for the left eye and the video signal for the right eye. Then, the driving unit alters the driving amount of driving in the overdrive operation according to the times at which the light transmittance through the glasses device is switched in response to the glasses control signal.

Thus, the amount of driving in the overdrive operation can be increased when the light is directed to the right eye or the left eye earlier than expected, reducing the amount of the crosstalk.

In addition, in the aforementioned video display device, it is preferable that the video display unit comprises a liquid crystal panel unit which modulates the light entered from behind according to the video signal for the left eye and the video signal for the right eye to display the video image for the left eye corresponding to the video signal for the left eye and the video image for the right eye corresponding to the video signal for the right eye, and a backlight which illuminates the liquid crystal panel unit from behind, wherein the driving unit drives the liquid crystal panel unit in such a manner that the transmittance is controlled by the driving amount based on each of the video signal for the left eye and the video signal for the right eye, and wherein the overdrive operation drives the liquid crystal panel unit by the driving amount appropriate for the transmittance that is equal to or higher than the transmittance required for the target luminance when the liquid crystal panel unit is driven such that the transmittance is increased to obtain the target luminance, and drives the liquid crystal panel unit according to a driving amount corresponding to the transmittance that is equal to or lower than the transmittance required for the target luminance when the liquid crystal panel unit is driven such that the transmittance is reduced to obtain the target luminance.

According to this configuration, the liquid crystal panel unit is driven in such a manner that the transmittance is controlled by the driving amount based on each of the video signal for the left eye and the video signal for the right eye. In the overdrive operation, the liquid crystal panel unit is driven by the driving amount appropriate for the transmittance that is equal to or higher than the transmittance required for the target luminance when the liquid crystal panel unit is driven such that the transmittance is increased to obtain the target luminance, and the liquid crystal panel unit is driven according to a driving amount corresponding to the transmittance that is equal to or lower than the transmittance required for the target luminance when the liquid crystal panel unit is driven such that the transmittance is reduced to obtain the target luminance.

Thus, the liquid crystal panel unit is driven by the driving amount appropriate for the transmittance that is equal to or higher than the transmittance required for the target luminance when the liquid crystal panel unit is driven such that the transmittance is increased to obtain the target luminance, and the liquid crystal panel unit is driven according to a driving amount corresponding to the transmittance that is equal to or lower than the transmittance required for the target luminance when the liquid crystal panel unit is driven such that the transmittance is reduced to obtain the target luminance. Therefore, the luminance of the video image for the left eye and the video image for the right eye displayed on the video display unit can be brought up to the target luminance, avoiding the occurrence of the crosstalk in stereoscopic video images.

A video view system according to another aspect of the present invention comprises a video display device as described in any of the above, and a glasses device including a shutter for the left eye that adjusts the amount of light reaching the left eye of a viewer and a shutter for the right eye that adjusts the amount of light reaching the right eye of a viewer.

According to this configuration, the video display unit displays the video image for the left eye corresponding to the video signal for the left eye and the video image for the right eye corresponding to the video signal for the right eye. The driving unit drives the video display unit by executing at least two times of write-scanning respectively according to the driving amount corresponding to the video signal for the left eye or the video signal for the right eye. In executing respective write-scanning, the overdrive operation is performed in which the video display unit is driven according to a driving amount corresponding to the luminance that is equal to or higher than the target luminance when the video display unit is driven such that the luminance is enhanced to obtain the target luminance determined according to the video signal for the left eye or the video signal for the right eye, and the video display unit is driven according to a driving amount corresponding to the luminance that is equal to or lower than the target luminance when the video display unit is driven such that the luminance is suppressed to obtain the target luminance.

Thus, the video display unit is driven according to a driving amount corresponding to the luminance that is equal to or higher than the target luminance when the video display unit is driven such that the luminance is enhanced to obtain the target luminance determined according to the video signal for the left eye or the video signal for the right eye, and the video display unit is driven according to a driving amount corresponding to the luminance that is equal to or lower than the target luminance when the video display unit is driven such that the luminance is suppressed to obtain the target luminance. Thus, the luminance of the video image for the left eye and the video image for the right eye displayed on the video display unit can be brought up to the target luminance, avoiding the occurrence of the crosstalk in stereoscopic video images.

It should be noted that the specific embodiments or examples described in the section entitled Detailed Description of the Invention are for the purpose of clarifying the technical details of the present invention. The present invention should not be interpreted in a narrow sense to be limited to these specific embodiments, and may be modified within the spirit of the present invention and the scope of the claims.

The video display device according to the present invention can avoid the occurrence of the crosstalk in the stereoscopic video images, and is useful as a video display device on which video images are displayed for allowing a viewer to perceive the video images stereoscopically and a video view system with which the viewer can see the video images displayed on the display device.

1. A video display device comprising:
a video display unit on which a video image for the left eye corresponding to a video signal for the left eye and a video image for the right eye corresponding to a video signal for the right eye are displayed; and
a driving unit that performs first write-scanning and second write-scanning for the video signal for the left eye and the video signal for the right eye, respectively, and performs write-scanning according to a driving amount based on the video signal for the left eye or the video signal for the right eye in order to drive the video display unit, wherein
the driving unit performing first overdrive operation in the first write-scanning for the video signal for the left eye or the video signal for the right eye, and performing second overdrive operation in the second write-scanning for the video signal for the left eye or the video signal for the right eye,
the first overdrive operation being for driving the video display unit according to a driving amount corresponding to a first luminance that is equal to or higher than a target luminance when the video display unit is driven such that the luminance is enhanced to obtain the target luminance determined according to the video signal for the left eye or the video signal for the right eye, and for driving the video display unit according to a driving amount corresponding to a second luminance that is equal to or lower than the target luminance when the video display unit is driven such that the luminance is suppressed to obtain the target luminance, and
the second overdrive operation being for driving the video display unit according to a driving amount that is different from the driving amount corresponding to the first luminance and the second luminance in the first overdrive operation, or for driving the video display unit in accordance with a driving amount corresponding to the luminance that is equal to the target luminance.

2. The video display device according to claim 1, further comprising a temperature detection unit for detecting a temperature of the video display unit, wherein
the driving unit alters the driving amount of driving in the first overdrive operation or the second overdrive operation according to the temperature detected by the temperature detection unit.

3. The video display device according to claim 1, further comprising a glasses control unit which generates a glasses control signal for switching between the right and left eyes light transmittance through a glasses device that transmits light alternately towards the right and left eyes according to the video signal for the left eye and the video signal for the right eye, wherein
the driving unit alters the driving amount of driving in the first overdrive operation or the second overdrive operation according to timing, at which the light transmittance through the glasses device is switched in response to the glasses control signal generated by the glasses control unit.
